(19) United States
(12) Patent Application Publication
(10) Pub. No.: US 2023/0408333 A1
(43) Pub. Date: Dec. 21, 2023

(54) Benchtop Optical Spectroscopy Providing Improved Workflow

(71) Applicant: Radom Corporation, West Allis, WI (US)

(72) Inventors: Ashok Menon, Shorewood, WI (US); Velibor Pikelja, Milwaukee, WI (US); Jovan Jevtic, Menasha, WI (US)

(21) Appl. No.: 18/333,603

(22) Filed: Jun. 13, 2023

Related U.S. Application Data
(60) Provisional application No. 63/366,423, filed on Jun. 15, 2022.

(51) Int. Cl. G01J 3/02; H05H 1/46

(52) U.S. Cl. CPC G01J 3/0291; G01J 3/0208; H05H 1/461

(57) ABSTRACT

A portable, optical spectrometer provides an extended ignition arc allowing high-voltage components to be contained within a protective housing. Automatic plasma initiation is managed through an optical plasma detector distinguishing plasma contained in the plasma region from breakout plasma. A negative pressure vent receives gases received from the plasma and cools these gases prior to receipt by a remote vent fan through a conduit having sheathing air bleed openings around the vent mixing with other cooling air streams for the electronics. A spring-biased sample jet tube holder allows ready removal and replacement of the sample jet tube while preserving proper alignment with the plasma region.

### CROSS REFERENCE TO RELATED APPLICATION

This application claims the benefit of U.S. provisional application 63/366,423 filed Jun. 15, 2022 and hereby incorporated by reference.

### STATEMENT REGARDING FEDERALLY SPONSORED RESEARCH OR DEVELOPMENT

--

### BACKGROUND OF THE INVENTION

The present invention relates to optical spectroscopy, and in particular, to a benchtop optical spectroscope providing simplified operation.

Emission spectroscopy analyzes the light frequencies produced by heated elements or compounds resulting from atoms or molecules making a transition from higher to lower energy states.

Inductively-coupled plasma atomic emission spectroscopy is a type of emission spectroscopy that uses a plasma to heat the materials being analyzed. The plasma, in this case, is produced by the inductive electrical coupling of energy to a gas such as argon. Spectroscopes employing inductively-coupled plasma may provide a sample feeding mechanism such as a pump and atomizer producing an aerosolized analyte material carried by argon to the vicinity of an inductive loop that creates a plasma. The plasma heats the analyte promoting light emissions received by an optical system (spectroscope assembly) that resolves the different frequencies of the light to output a desired emission spectrograph indicating light amplitude as a function of frequency over a range of frequencies.

Commercial inductively-coupled plasma emission spectroscopes weigh many hundreds of pounds and require substantial bench top space substantially limiting their use in many important applications including those that would benefit from rapid analysis at locations remote to the laboratory. U.S. Pat. No. 10,900,907, assigned to the assignee of the present invention and hereby incorporated by reference, addresses this problem by providing a compact plasma mechanism using a dielectric ring for plasma generation with optical sensing along the plasma axis to boost the signal-to-noise ratio, providing a number of benefits including allowing the use of a nitrogen carrier gas.

While the above described spectrometer has the potential to greatly increase the availability of optical spectroscopy to industry and laboratories, operation of an inductively-coupled optical spectroscope can be procedurally complicated requiring an individual trained in managing the gases, chemicals, and high-voltage conductors.

### SUMMARY OF THE INVENTION

The present invention greatly simplifies the operation of an inductively-coupled optical spectroscope through a number of innovations including the development of a remote plasma ignition system removing high-voltage conductors from the work area; a plasma detector allowing plasma initiation to be largely automated; a negative pressure vent chimney providing improved management of hot plasma gases and automatic detection of venting failure; and a plasma tube holder permitting rapid replacement of the plasma tube while shielding the user from high voltages and temperatures within the spectroscope housing.

Specifically, in one embodiment, the invention provides a plasma emission spectroscope having a housing supporting: an inductive plasma generator receiving electrical power to generate plasma in a plasma region, a sample jet tube for introducing a sample into the plasma region for spectrographic analysis, and an optical collimation system capturing light from the plasma heated sample. The spectroscope also provides a ground surface at ground potential and adjacent to the plasma region and an igniter providing a gas channel containing a high-voltage electrode. A high-voltage power supply provides a conductor communicating with the high-voltage electrode to switchably apply a high voltage to the high-voltage electrode to generate an arc in gas passing through the gas channel between the high-voltage electrode and the ground surface. An insulating conduit communicates gas from the gas channel of the igniter to the plasma region so that the high-voltage electrode, high-voltage power supply and conductor may be enclosed in a portion of the housing removed from operator access during operation of the igniter.

It is thus a feature of at least one embodiment of the invention to sequester the high-voltage components of the spectroscope away from the operator within the protective housing. The present inventors have determined that sufficiently long arc lengths are attainable, for example, with argon gas, to practically provide this protective isolation. The present invention can be contrasted to systems that have high-voltage wiring extending out of the housing to a T coupling or the like initiating an arc close to the plasma source.

The housing may be at ground potential.

It is thus a feature of at least one embodiment of the invention to provide a grounded shield around the high-voltage components.

In one embodiment, the insulating conduit may include at least a portion of flexible polymer tubing greater than 20 cm long.

It is thus a feature of at least one embodiment of the invention to provide a flexible conduit of sufficient length so as to not interfere with the connection of components by the operator during spectroscopy.

The spectroscope may further include an argon source providing gas through the gas channel during the application of high voltage to the high-voltage electrode.

It is thus a feature of at least one embodiment of the invention to employ a gas that can provide long arc length.

The spectroscope may further include an electrically actuable valve communicating via a second insulating conduit with the gas channel of the igniter to provide gas thereto wherein the electrical resistance between electrical conductors of the electrically actuable valve and the high-voltage electrode through the second conduit is greater than the electrical resistance between the high-voltage electrode and the ground surface during the flow of gas through the conduits.

It is thus a feature of at least one embodiment of the invention to provide an extended distance between the plasma and the high-voltage igniter by blocking reverse electrical flows upstream through the gas, for example, to the gas control valve.

The second insulating conduit may follow a curved path having a length of at least two times the distance between the high-voltage electrode and the electrically actuable valve.

It is thus a feature of at least one embodiment of the invention to provide a simple method of increasing the electrical resistance between a high-voltage electrode and the electrically actuable valve.

The spectroscope may further include an electrically insulating escutcheon having a mounting plate allowing passage of the first conduit therethrough and forming a wall of a portion of the housing protected from operator access during operation of the igniter, the insulating escutcheon separating the first conduit from electrically conducting walls of the housing by at least 1 cm.

It is thus a feature of at least one embodiment of the invention to permit initiation of the arc within the housing while avoiding conductive paths between the arc and the electrically shielding walls.

The first conduit may include a portion of high temperature glass proximate to the plasma region.

It is thus a feature of at least one embodiment of the invention to deliver the arc directly through the sample jet tube.

In one embodiment, the apparatus may provide a plasma emission spectroscope having an electronically controllable plasma generator having a dielectric resonator to generate a plasma in an axially extending plasma region within the resonator, a sample-handling system for introducing a sample into the plasma region, and an optical collimation system capturing light from the plasma region during introduction of the sample. At least two optical sensors are directed across the axis and spaced along the axis on opposite sides of the dielectric resonator, and an analysis circuit receives electrical signals from the optical sensors to indicate fugitive plasma outside of the plasma region when signals from the at least two optical sensors differ by a predetermined amount.

It is thus a feature of at least one embodiment of the invention to provide a reliable method of detecting not only the presence of plasma but it's correct location axially within the dielectric resonator as opposed to other points of high electrical field gradient, for example, at ends of the dielectric resonator.

The analysis circuit may compare the amplitude of the electrical signals from the at least two optical sensors.

It is thus a feature of at least one embodiment of the invention to allow as few as two sensors to accurately determine correct plasma ignition.

The analysis may deactivate the electronically controllable plasma generator in response to detection of fugitive plasma.

It is thus a feature of at least one embodiment of the invention to permit automatic plasma monitoring necessary for automatic plasma initiation and control.

The analysis circuit may include a frequency discriminator distinguishing high-frequency signals and low-frequency signals from either of the first and second optical sensors to indicate fugitive plasma based on a frequency of the signals from first or second optical sensors.

It is thus a feature of at least one embodiment of the invention to exploit the instability of fugitive plasma to further discriminate between proper and improper plasma initiation.

The apparatus may further include at least one axial optical sensor directed along the axis, and the analysis circuit may indicate a plasma ignition failure when the electrical signal from the axial optical sensor is less than a predetermined amount.

It is thus a feature of at least one embodiment of the invention to indicate plasma initiation as well as lack of fugitive plasma.

The analysis circuit may deactivate the electronically controllable plasma generator in response to plasma ignition failure of more than a predetermined duration.

It is thus a feature of at least one embodiment of the invention to accommodate an expected short period of plasma ignition and react only if that period is exceeded.

In one embodiment, the apparatus may provide an apparatus for plasma emission spectroscopy having a housing with a base on which the housing may be supported, the housing in turn supporting an inductive plasma generator receiving electrical power to generate plasma in a plasma region, a sample jet tube for introducing a gas-carried sample into the plasma region for spectrographic analysis along an axis, and an optical collimation system capturing light from the plasma heated sample. A plasma vent receives the gas-carried sample after passing through the plasma region and has an outlet adapted to attach to a vent fan and inlet positioned along the axis downstream from the sample jet tube. During operation, the plasma vent has an inlet pressure less than ambient air pressure.

It is thus a feature of at least one embodiment of the invention to contain the high temperature plasma exhaust within the protective housing while preventing exhaust leakage. The negative pressure vent operates to contain the hot gases and channel them safely from the housing into a vent system.

The inductive plasma generator may include a microwave generator having a heatsink and including a heatsink channel also attached to the vent outlet and wherein the plasma vent connects to the heatsink channel before the outlet to mix air from the heatsink channel with a gas-carried sample received from heatsink channel prior to the outlet.

It is thus a feature of at least one embodiment of the invention to greatly dilute the hot plasma gases while using an airstream that can serve to cool the microwave generator, the heated air from the microwave generator still being adequate cooling for the much higher temperature plasma gas.

The apparatus may further include a flow sensor in the heatsink channel upstream from its connection to the plasma vent.

It is thus a feature of at least one embodiment of the invention to provide a simple method of monitoring airflow allowing the necessary fan to be provided by an institutional vent system that will not be directly controlled by the spectroscopy machine and which is sufficiently downstream from the plasma to receive adequately cooled gas.

The optical collimation system may receive light along the axis and may further include an air knife directed across the axis between the inductive plasma generator and the optical collimation system so that air from the air knife is received by the plasma vent with the gas-carried sample.

It is thus a feature of at least one embodiment of the invention to permit the use of an air knife for shielding the collimation optics while accommodating the air knife exit gases plus the intermingle hot plasma gases.

The plasma vent may include a set of air-bleed openings around the inlet for drawing air into the plasma vent with the passage of the gas-carried sample from the plasma region, air from the air-bleed openings surrounding the gas-carried sample between the gas-carried sample and walls of the plasma vent.

It is thus a feature of at least one embodiment of the invention to contain the hot plasma gases in a constrained channel within the housing by sheathing those hot gases with an outer flow of ambient air that will eventually mix with those gases to cool them prior to exit into an institutional vent system.

In one embodiment the apparatus may provide a spectroscope having a housing supporting an electronically controllable plasma generator providing a dielectric resonator to generate a plasma in an axially extending plasma region within the resonator. A sample jet tube is positionable to extend along the axis and has a first and second inlet for receiving a sample and a sheath gas, respectively, and an outlet for directing the sample and sheath gas into the plasma region. An optical collimation system is positioned to capture light from the plasma region during introduction of the sample. A sample jet tube holder provides a spring-biased clamp with an operator that is accessible outside of the housing to move in a first direction separating portions of the spring-biased clamp to receive or remove the sample jet tube and in the second direction allowing the spring-biased clamp to close the portions about the sample jet tube and align the sample jet tube with the axis.

It is thus a feature of at least one embodiment of the invention to allow removal and replacement of the sample jet tube without significant insertion force on the sample jet tube or rotation that might dislodge connections, all the while ensuring proper alignment.

The sample jet tube may include a radially extending boss interfering with the sample jet tube holder to control an amount of insertion of the sample jet tube in the sample jet tube holder along the axis.

It is thus a feature of at least one embodiment of the invention to provide not only orientation but depth control of the sample jet tube that may be both fragile and subject to dimensional variation.

The sample jet tube holder may provide a central bore at an interface of the portions substantially equal to an outer cylindrical periphery of the sample jet tube to seal against the sample jet tube in the closed state.

It is thus a feature of at least one embodiment of the invention to provide a close sealing around the sample jet tube to limit the flow of gases into the housing near the sample jet tube that might interfere with proper operation of the spectroscope.

The sample jet tube holder may be a polymer material.

It is thus a feature of at least one embodiment of the invention to provide a structurally precise material offering reduced breakage risk to the sample jet tube.

The sample jet tube holder may form part of a housing wall of a housing portion enclosing a portion of the sample jet tube during operation of the plasma generator.

It is thus a feature of at least one embodiment of the invention to provide a sample jet tube holder completing a wall of the housing to shield the user from high voltages and temperatures within the housing and allowing proper alignment of the sample jet tube without access to the housing.

These particular objects and advantages may apply to only some embodiments falling within the claims and thus do not define the scope of the invention.

### BRIEF DESCRIPTION OF THE DRAWINGS

FIG. 1 is an interconnection diagram of the portable plasma source of the present invention, for example, as connected to a portable spectroscope, a laptop computer, different gas sources, and a vent system;

FIG. 2 a block diagram of the components of the portable plasma source of FIG. 1 showing various components controlled by a controller including a plasma-generating dielectric resonator excited by a microwave source and a vent system for receiving hot gases there from;

FIG. 3 is a fragmentary block diagram of an ignition system for the plasma generated by the dielectric resonator showing an igniter electrode communicating through a flexible conduit and spaced from a control valve to ensure proper arc direction;

FIG. 4 is a detailed cross-sectional elevational view of the vent system of FIG. 2 from a right side of the housing showing a hot gas flow path and various other gas flows including that from an air knife and from a mainstream cooling the microwave power source;

FIG. 5 is a cross-sectional elevational view perpendicular to that of FIG. 4 from a rear side of the housing;

FIG. 6 is a simplified cross-sectional view of the dielectric resonator of FIG. 2 showing the positioning of light sensors to detect plasma and fugitive plasma;

FIG. 7 is a logic table showing interpretation of the signals from the sensor of FIG. 6 by the controller of FIG. 2;

FIG. 8 is an exploded fragmentary view of a sample jet tube holder and sample jet tube, the sample jet tube holder being in an open position for receiving the sample jet tube vertically therein;

FIG. 9 is a perspective view of the underside of the sample jet tube holder in a close configuration; and

FIG. 10 is a fragmentary exploded view of the base plate of the housing of the spectroscope of FIG. 1 showing a removable tray magnetically aligned after insertion.

### DETAILED DESCRIPTION OF THE PREFERRED EMBODIMENT

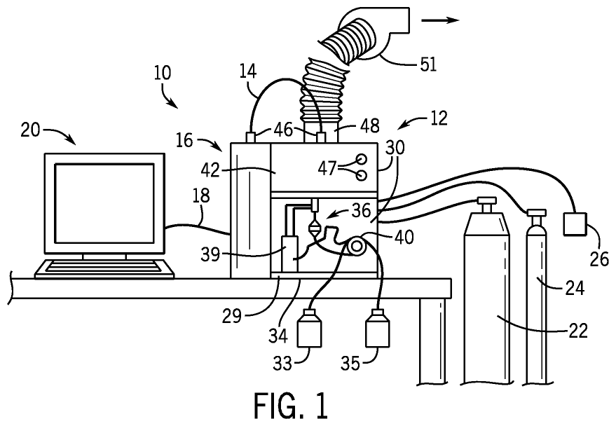

Referring now to FIG. 1, an inductively-coupled plasma emission spectroscopy system 10 may provide a plasma unit 12 coupled by an optical fiber 14 to a fiber-optic spectrometer 16, the latter communicating by means of a USB cable 18 to a laptop computer 20 or the like.

As will be discussed further below, the plasma unit 12 may receive an external source of nitrogen, for example, held under compression within a nitrogen tank 22, as well as a source of argon in a smaller argon tank 24. In some cases, the source of nitrogen may be replaced with a standard electric air pump 26 providing compressed, filtered air having significant nitrogen content.

In one embodiment, the spectroscopy system 10 may have a weight less than 50 pounds such as may be lifted and carried by a single individual and may fit within an area of four square feet on a bench top or the like.

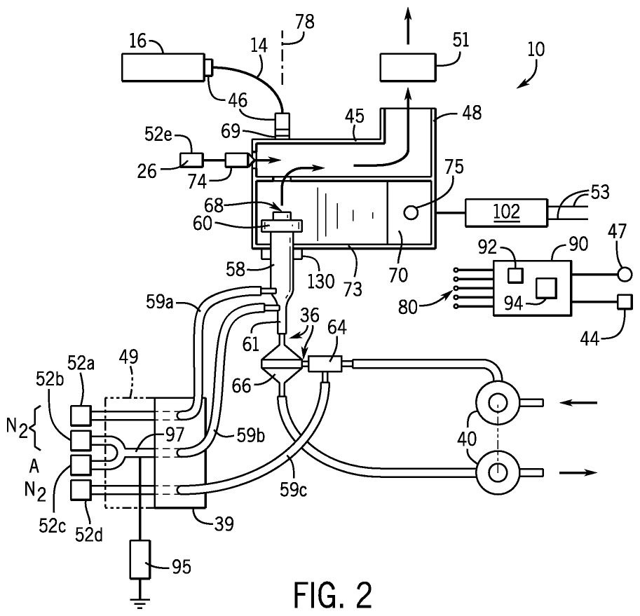

Referring also to FIG. 2, a housing 30 of the plasma unit 12 may be constructed of a conductive metal such as aluminum to provide electrical shielding and resistance to solvents, elevated temperatures, and the like and may include an integrated sample bench 34 extending forwardly along its base to provide an upward platform holding a retention tray 29. The retention tray 29 may support a sample vessel 35 of the material being analyzed and a waste container 33, both shown displaced from the retention tray 29 for clarity.

A vertical wall 38 of the housing 30, behind the sample bench 34 and extending upward therefrom may expose an electrically controlled pump 40 (for example, a peristaltic pump) providing an analyte pumped from the sample vessel 35 to an atomizer assembly 36 and returning waste from the lower outlet of the atomizer assembly 36 to the waste container 33. The vertical wall 38 may also provide for releasable gas line connectors at a manifold 49 allowing access to the gas flow from internal gas valves 52a-52d as will be discussed below.

An upper output of the atomizer assembly 36 is directed upward to the lower surface of an overhang portion 42 of the housing 30 holding a contained plasma source. A front panel of the housing 30 of the overhang portion 42 may provide for a power on button providing power to the components of the spectroscopy system 10 and a plasma start button 47 that may be pressed to control a plasma generator enclosed within the housing 30 to automatically ignite and maintain a plasma.

An upper wall of the housing 30 provides fiber-optic connectors 46 for the fiber-optic 14 and an exhaust outlet 48 that may be connected to a fume exhaust, for example, incorporated into a laboratory environment as part of the building infrastructure and having a vent fan 51 communicating through conduit 54. Generally the vent fan 51 may be remotely located and independently controlled from the spectroscopy system 10. A power cord 53 provides a connection to a standard wall outlet to provide power to the spectroscopy system 10.

Argon from argon tank 24 and nitrogen from nitrogen tank 22 may be received by gas control valves 52a-52e within the housing 30, with gas control valve 52a connected to the argon tank 24 and gas control valves 52b-52d each connected to the nitrogen tank 22, the latter by means of a three-outlet manifold 49. A first outlet of the manifold 49 may provide a source of nitrogen to an outlet on escutcheon 39 that may be connected by a flexible tubing 59a to a first inlet on a sample jet tube 58. A second outlet of the manifold 49 may alternately provide argon or nitrogen according to valves 52b and 52c by means of flexible tubing 59b connected to a second inlet on the sample jet tube 58, the nitrogen used during normal operation and the argon used for igniting the plasma as will be discussed below. For this purpose of ignition, the manifold may include a high-voltage electrode 97 communicating with a high-voltage power supply 95 providing a source of controllable high-voltage to ignite an arc in the argon. The high-voltage electrode 97 in the channel around it provides an igniter 56. A third outlet of the manifold 49 may connect via a flexible tubing 59c with an atomizer 64 as will be discussed further.

Gas control valve 52e may receive compressed air or other gas for use with an air knife as will also be discussed below. Gas control valves 52b-52d may be mass flow controllers allowing precise control of mass flow.

The first and second inlets to the sample jet tube 58 provide cooling and sheath gases that will surround a sample introduced through an axial inlet 61 in the sample jet tube 58. Operation of the sample jet tube 58 in this regard is analogous to that described in US patent assigned to the assignee of the present invention and hereby incorporated by reference. Generally the sample jet tube 58 will be a quartz or alumina material having a generally cylindrical outer form and concentric inner channels aligned with a vertical axis 78 of the sample jet tube 58.

The sample introduced through the axial inlet 61 may be received from a vortex separator 66, the latter receiving an atomized sample obtained from the atomizer 64. The atomizer 64 receive sample material from the sample vessel 35 after passage through the pump 40. The vortex separator 66 passes only the finest suspended analyte particles up into the sample jet 258 and diverts the larger particles centrifugally downward into the waste container 33.

The upper edge of the sample jet tube 58 will pass into the housing 30 and be received immediately below the dielectric ring 60 so that gas and the sample from the sample jet tube 58 pass into a plasma generation region 68 centered on axis 78 of the dielectric ring 60 and aligned with the axis 78 of the sample jet tube 58. The dielectric ring 60 is inductively-coupled to a microwave generator 70 through a microwave antenna 75 and waveguide 73, the microwave generator 70, for example, being a magnetron operating at 1000 to 1500 watts of a type described in U.S. Pat. No. 9,491,841 assigned to the assignees of the present invention and hereby incorporated by reference.

During operation, hot gases received from the plasma region 68 pass upward from the radiofrequency waveguide to strike a horizontal air plume 72 from air knife 74 fed from gas control valve 52e. Exhaust gases are directed horizontally along a vent pipe 45 positioned above in parallel to the waveguide 73 and directed from the front to a rear of the housing 30. The light from the plasma region 68 passes through the horizontal air plume 72 to be received by a collimator system of fused-silica collimating lenses 69 to be coupled to the fiber-optic 14 through the connector 46. The horizontal air plume 72 protects the collimating lenses 69 from heat and reactive gases while allowing an axial view of the plasma region 68 for improved signal strength along the elongated plasma region 68. Light received by the fiber-optic 14 travels to the fiber-optic spectrometer 16 described above.

A controller 90, for example, including a processor 92 and a memory 94 holding a stored program may control each of the gas control valves 52a-52e (which provide valving action and control of mass flow), the pump 40, the microwave generator 70, and the ignition power supply 95. Generally, the controller 90 will receive electrical signals from the buttons 47 and a set of sensors 80 as will be discussed in greater detail below.

The controller 90 may provide for basic control functionality and may also communicate, for example, through a standard communication interface 100 such as a USB port 44, Bluetooth connection, or the like to the external computer 20, the latter of which may be a laptop, tablet, smart phone, or the like, greatly reducing the weight of the spectroscopy system 10 by allowing external computational and display functionality for computing and displaying a spectrograph as well as controlling the plasma unit 12 to be handled by the computer 20. It will be appreciated that other communication interfaces 100 may alternatively provide cellular telephone, Wi-Fi, or the like, permitting the use of the spectroscopy system 10 for remote monitoring stations (such as river pollution monitoring stations).

An onboard power supply 102 may provide power to the microwave generator 70 controller 90 and other electrical components using power received through a standard line cord requiring 15-ampere or less service.

The spectrometer 16 may provide a spectral range of 190-850 nm with a resolution of 3.7 μm at 253 nm and may use a back illuminated EMCCD camera, and importantly, the spectrometer 16 should have a sensitivity of at least between 192 nm and 460 nm. For rare earths that may be analyzed with this invention, the range of interest is approximately 350-550 nm. Resolution greater than 50 μm is not favored, 10-20 μm is acceptable, and below 10 μm is the preferred. Ideally the camera incorporated with the portable fiber-optic spectrometer 16 should have a Peltier cooled sensor being of any of CCD, EMCCD, or CMOS type. Spectrometers could be of Echelle type (2D simultaneous type) or conventional with a 1D sensor array providing one line or a range of wavelengths at a time.

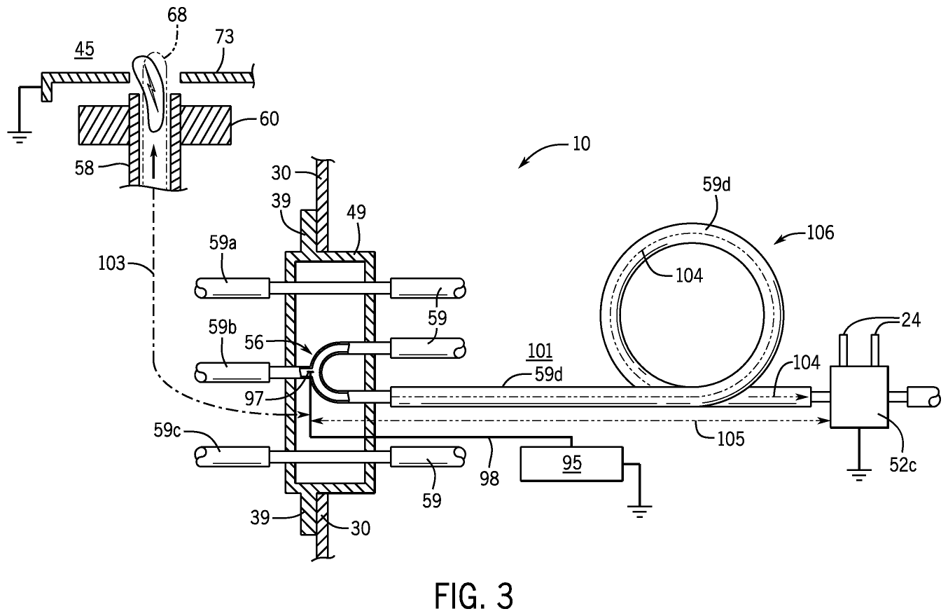

Referring now to FIG. 3, ignition of plasma within the plasma region 68 may be accomplished while retaining the high-voltage electrode 97, the power supply 95, and the connecting wiring 98 within an enclosed portion 101 of the housing 30 removed from immediate accessibility by a user of the spectroscopy system 10. In one embodiment, the high-voltage electrode 97 may be positioned within an insulating portion of the manifold 49 being part of the housing 30 and filling an opening in a metallic wall of the housing 30 as held by the escutcheon 39. The escutcheon 39 attaches the manifold 49 to the housing 30 so as to provide at least 1 cm of distance between the high-voltage electrode 97 and the metallic walls of the housing 30 to prevent arcing therebetween. All portions of the manifold 49 and connecting tubing 59 to and from the manifold 49 are electrically insulating polymer materials.

The location of the high-voltage electrode 97 within the housing 30 is possible by employing an extremely long electrical arc length 103 between the high-voltage electrode 97 and a ground point, for example, the housing of the radiofrequency shield 43 above the dielectric ring 60. Generally, this distance can be greater than 20 cm offering a length of tubing 59b that permits freedom of assembly of tubing to the sample jet tube 58. Importantly, the path of this arc length 103, prior to arcing but during the flow of argon, presents a lower electrical resistance than a short path 104 between the high-voltage electrode 97 and the next closest metallic conductor, being the conductive elements of valve 52c. This higher electrical resistance, which causes initial arcing to occur only in the direction of the dielectric ring 60, is ensured by providing a length of tubing 59d connecting the valve 52c to the manifold 49 longer than the arc length 103 and, for example, at least two times longer than the actual separation 105 between the manifold 49 and the valve 52c. Tubing 59d may be collected in a loop 106 within the housing 30, thus allowing arbitrary path length extension. It will be appreciated that alternative techniques may be used to enforce this resistance, for example, by packing the tubing 59d with particles that would increase the effective path length of travel through the argon.

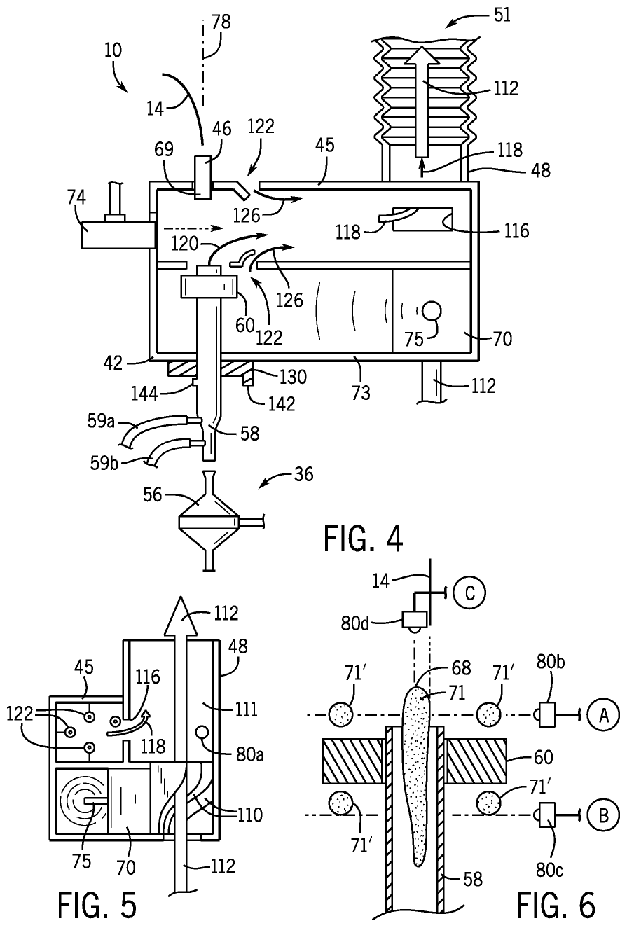

Referring now to FIGS. 4 and 5, and as best seen in FIG. 5, the exhaust outlet 48 is positioned above a heatsink assembly 110 of the microwave generator 70 providing a vertical channel 111 of airflow 112 upward through the heatsink assembly 110 and out of the exhaust outlet 48. The vent pipe 45 communicates laterally with the vertical channel 111 through in opening 116 creating a venturi section pulling heated air 118 therethrough and out of the vent pipe 45.

As best seen in FIG. 4, the vent pipe 45 has a limited inlet area so as to hold a negative pressure inside of vent pipe 45 with respect to the outside ambient atmospheric pressure. This ensures full capture of the exhaust gases 120 passing out of the dielectric ring 60 after passing through the plasma while also accommodating the air from the air knife 74 (of high velocity but low flow) and air from air bleed openings 122. These latter air bleed openings 122 are positioned around (on all four sides of a rectangular cross-section of the vent pipe 45) the inlet end of the vent pipe 45 to provide a cooling airflow 126 forming a sheath around the hot gases from the plasma. The air bleed openings 122 are tipped to direct incoming airflow 126 along a horizontal length of the vent pipe 45 to prevent initial mixing with the exhaust gases 120 to provide this protective shielding feature. As the cooling airflow 126 passes along the path of the vent pipe 45, the cooling airflow 126 gradually mixes with the hot gases 120 to lower their combined temperature while minimizing heating of the vent pipe 45.

The combination of the airflow 126 and hot gases 120 forms a heated gas flow 118 ultimately mixing with the airflow 112 shown in FIG. 5 as drawn through the venturi of opening 116. Generally the airflow 112 through vertical channel 111 will be much greater than airflow 118 ensuring that the air exiting the exhaust outlet 48 is sufficiently cool to be received by a standard building ducting system.

The operation of the venturi is such as to hold the vent pipe 45 at negative ambient pressure so long as air is flowing through vertical channel 111. This allows monitoring of airflow through the vent pipe 45 inferentially using a differential pressure sensor 80 communicating with the vertical channel 111 upstream of the opening 116 and thus shielding the sensor from gases at elevated temperatures. Such monitoring permits the spectroscopy system 10 to eliminate a self-contained fan and rather rely on the building vent fan 51 even though the latter may be on a separate control circuit or otherwise not directly sensed by the spectroscopy system 10. Loss of a signal from the pressure sensor 80 causes a shutting down the plasma per the inference that venting is no longer available.

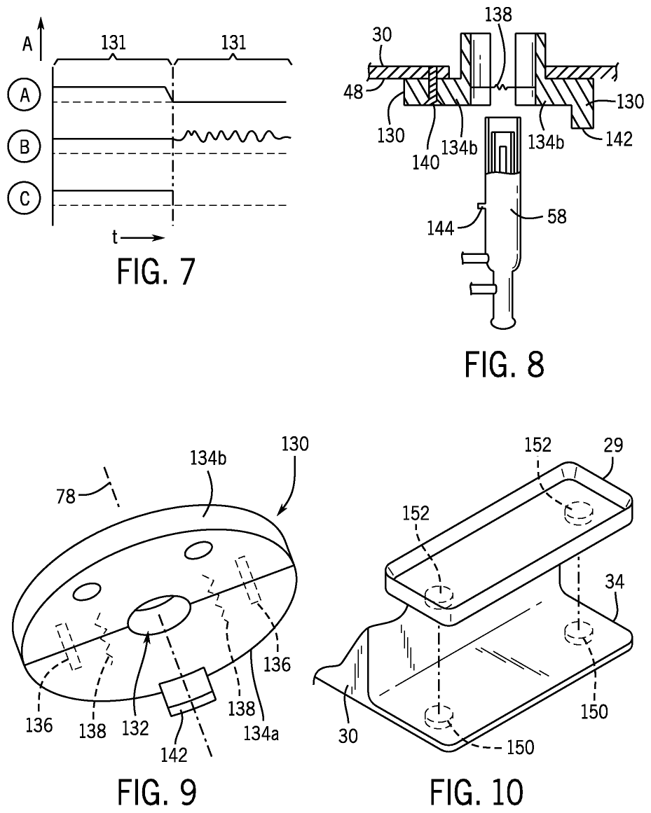

Referring now to FIGS. 6 and 7, during operation of the spectroscopy system 10, the dielectric ring 60 will conduct an inductive current generating regions of high electrical gradient 71 that can generate plasma. The plasma desirably forms in a vertically elongated plasma region 68 aligned with the axis 78 of the sample jet tube 58 and extending above and below the dielectric ring 60; however, there can be other areas of high gradient 71′ outside of the region of high electrical gradient 71 that may alternatively or in addition produce plasma, for example, sustained in atmospheric nitrogen. Plasma in the regions 71′ will not produce the necessary spectrographic optical signal and may be damaging over an extended period of time, and for this reason, human confirmation of the plasma ignition and location would normally be required.

In one embodiment, the present invention employs a set of optical sensors 80b, 80c and 80d to detect fugitive plasma in region 71′ and to confirm plasma in region 71. Generally sensor 80b will be directed horizontally across the axis 78 of the sample jet tube 58 along the top of the ring 60, and sensor 80c will be directed horizontally across the axis 78 of the sample jet tube 58 along the bottom of the ring 60 to independently measure light emitted from these areas. Fugitive plasma will generally be localized either on the top or the bottom of the ring 60 in regions 71′ and thus any imbalance in amplitude of light received by sensors 80b and 80c indicates fugitive plasma in regions 71′ and may be used to terminate plasma generation by turning off the microwave generator 70 and indicating an error condition. Plasma in region 71′ may also be erratic, producing an AC signal and thus may be further confirmed by means of a frequency discriminator distinguishing the frequency of light received by sensors 80b and 80c.

A third sensor 80d may optionally be directed downwardly along the axis 78 of the sample jet tube 58 to the side of the fiber-optic 14 to detect light from plasma in region 71 and thus confirm plasma ignition. Failure of plasma to ignite (even without fugitive plasma at region 71′) for more than a predetermined time will also cause shutdown of the spectroscopy system 10 and outputting of error indication.

Referring now to FIG. 7, the controller 90 may indicate a proper operational state 131 when signal A from sensor 80b and signal B from sensor 80c are of at least a predetermined threshold amplitude with low high-frequency content indicating plasma in region 71 extending above and below the dielectric ring 60. Measurements indicating this operating state 131 provide automatic confirmation of proper plasma ignition. This state 131 may be confirmed by a signal above a predetermined amplitude from sensor 80d. Conversely, an improper operational state 133 is indicated when either or both signals A and B are not above the predetermined threshold level or when there is substantial high-frequency content in one or both of signals A and B or there is no signal from C when sensor 80d is used. The improper operational state 133 triggers an error condition in which microwave energy is turned off and the operators notified.

Referring now to FIGS. 4, 8 and 9, the sample jet tube 58, during operation, is partially inserted into the housing 30 through a lower wall of the overhang portion 42 and held by means of a spring-loaded collar 130. The spring-loaded collar 130 provides a cylindrical central bore 132 formed at the interface of a first and second collar half 134a and 134b. The first and second collar half 134a and 134b may move together and apart in a direction radial to the bore 132, for example, as guided by dowel pins 136 and biased to a closed state together by helical extension springs 138 held in blind bores and pinned to the halves 134a and 134b, respectively. Half 134b may be fixed to the housing 30 by machine screws 140 or the like while half 134a is free to slide respect to the half 134b as moved by handle operator 142. The central bore 132 is sized to closely fit the outer circumference of the sample jet tube 58 when the sample jet tube 58 is inserted therein thus limiting access to the interior of the housing 30 and the high temperature plasma while also ensuring correct alignment of the sample jet tube 58 with the dielectric ring 60. This close fit also prevents undesirable airstreams upward into the housing 30 along the sample jet tube 58. A radially outwardly extending nub 144 on the sample jet tube 58 abuts an undersurface of the collar 130 controlling the insertion distance of the sample jet tube 58 allowing proper insertion depth without the need for the user having access, physically or visually, to the interior of the housing 30 thereby protecting the user from the plasma. Collar 130 may be fabricated of a thermoplastic material to provide a grip less likely to break the sample jet tube 58.

Referring now to FIG. 10 and FIG. 1, the sample bench 34 of the housing 30 may provide a horizontal aluminum plate with permanent magnets 150 mounted on the undersurface (shown here in phantom) that match corresponding magnets 152 (also shown in phantom) on the undersurface of the retention tray 29). Mutual attraction between these magnets allows the retention tray 29 to be removed for cleaning and then quickly reinstalled for incorrect alignment. An unbroken surface of the sample bench 34 prevents retention of spilled liquids and provides easy cleaning.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a controller” or “the microprocessor” and “the processor,” can be understood to include one or more microprocessors that can communicate in a stand-alone and/or a distributed environment(s), and can thus be configured to communicate via wired or wireless communications with other processors, where such one or more processors can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

What we claim is:

1. An apparatus for plasma emission spectroscopy comprising:
a housing having a base on which the housing may be supported, the housing in turn supporting:
an inductive plasma generator receiving electrical power to generate plasma in a plasma region;
a sample jet tube for introducing a sample into the plasma region for spectrographic analysis;
an optical collimation system capturing light from the plasma heated sample;
a ground surface at ground potential and adjacent to the plasma region;
an igniter providing a gas channel containing a high-voltage electrode;
a high-voltage power supply providing a conductor communicating with the high-voltage electrode to switchably apply a high voltage to the high-voltage electrode to generate an arc in gas passing through the gas channel between the high-voltage electrode and the ground surface; and
an insulating conduit communicating gas from the gas channel of the igniter to the plasma region;
wherein the high-voltage electrode, high-voltage power supply and conductor are enclosed in a portion of the housing removed from operator access during operation of the igniter.

2. The apparatus of claim 1 wherein the housing is at ground potential.

3. The apparatus of claim 1 wherein the insulating conduit includes at least a portion of flexible polymer tubing greater than twenty centimeters long.

4. The apparatus of claim 1 further including an argon source providing gas through the gas channel during an application of high voltage to the high-voltage electrode.

5. The apparatus of claim 1 further including an electrically actuable valve communicating via a second insulating conduit with the gas channel of the igniter to provide gas thereto wherein the electrical resistance between electrical conductors of the electrically actuable valve and the high-voltage electrode through the second conduit is greater than the electrical resistance between the high-voltage electrode and the ground surface during a flow of gas through the conduits.

6. The apparatus of claim 5 wherein the second insulating conduit follows a curved path having a length of at least two times a distance between the high-voltage electrode and the electrically actuable valve.

7. The apparatus of claim 1 further including an electrically insulating escutcheon having a mounting plate allowing passage of the insulating conduit therethrough and forming a wall of a portion of the housing protected from operator access during operation of the igniter, the insulating escutcheon separating the insulating conduit from electrically conducting walls of the housing by at least one cm.

8. The apparatus of claim 1 wherein the insulating conduit includes a portion of high-temperature glass proximate to the plasma region.

9. An apparatus for plasma emission spectroscopy comprising:
an electronically controllable plasma generator providing a dielectric resonator to generate a plasma in an axially extending plasma region within the resonator;
a sample-handling system for introducing a sample into the plasma region;
an optical collimation system capturing light from the plasma region during introduction of the sample;
at least two optical sensors directed across the axis and spaced along the axis on opposite sides of the dielectric resonator; and
an analysis circuit receiving electrical signals from the optical sensors to indicate fugitive plasma outside of the plasma region when signals from the at least two optical sensors differ by a predetermined amount.

10. The apparatus of claim 9 wherein the analysis circuit compares an amplitude of the electrical signals from the at least two optical sensors.

11. The apparatus of claim 9 wherein the analysis circuit deactivates the electronically controllable plasma generator in response to detection of fugitive plasma.

12. The apparatus of claim 9 wherein the analysis circuit includes a frequency discriminator distinguishing high-frequency signals and low-frequency signals from at least one of the at least two optical sensors to indicate fugitive plasma based on a frequency of the signals from the at least one first and second optical sensor.

13. The apparatus of claim 9 further including at least one axial optical sensor directed along the axis and wherein the analysis circuit indicates a plasma ignition failure when the electrical signal from the axial optical sensor is less than a predetermined amount.

14. The apparatus of claim 13 wherein the analysis circuit deactivates the electronically controllable plasma generator in response to plasma ignition failure of more than a predetermined duration.

15. An apparatus for plasma emission spectroscopy comprising:
an electronically controllable plasma generator providing a dielectric resonator to generate a plasma in an axially extending plasma region within the resonator;
a sample-handling system for introducing a sample into the plasma region;
an optical collimation system capturing light from the plasma region during introduction of the sample;
at least one optical sensor directed along the axis in the plasma region; and
an analysis circuit receiving an electrical signal from the at least one optical sensor to indicate a plasma ignition failure when the at least one signal is below a predetermined threshold.

16. The apparatus of claim 15 wherein the analysis circuit deactivates the electronically controllable plasma generator in response to plasma ignition failure of more than a predetermined duration.

17. An apparatus for plasma emission spectroscopy comprising:
a housing having a base on which the housing may be supported, the housing in turn supporting:
an inductive plasma generator receiving electrical power to generate plasma in a plasma region;
a sample jet tube for introducing a gas-carried sample into the plasma region for spectrographic analysis along an axis;
an optical collimation system capturing light from the plasma heated sample;
a plasma vent receiving the gas-carried sample after passing through the plasma region and having an outlet adapted to attached to a vent fan and inlet positioned along the axis downstream from the sample jet tube and having an inlet pressure less than ambient air pressure during operation of the vent fan, sample jet tube, and plasma generator.

18. The apparatus of claim 17 wherein the inductive plasma generator includes a microwave generator having a heatsink and including a heatsink channel also attached to the vent outlet and wherein the plasma vent connects to the heatsink channel before the outlet to mix air from the heatsink channel with a gas-carried sample received from the heatsink channel prior to the outlet.

19. The apparatus of claim 18 further including a flow sensor in the heatsink channel upstream from its connection to the plasma vent.

20. The apparatus of claim 17 wherein the optical collimation system receives light along the axis and further including an air knife directed across the axis between the inductive plasma generator and the optical collimation system so that air from the air knife is received by the plasma vent with the gas-carried sample.

21. The apparatus of claim 17 wherein the plasma vent includes a set of air bleed openings around the inlet for drawing air into the plasma vent with a passage of the gas-carried sample from the plasma region, air from the air bleed openings surrounding the gas-carried sample between the gas-carried sample and walls of the plasma vent.

22. An apparatus for plasma emission spectroscopy comprising:
a housing having a base on which the housing may be supported, the housing in turn supporting:
an electronically controllable plasma generator providing a dielectric resonator to generate a plasma in an axially extending plasma region within the resonator;
a sample jet tube positionable to extend along the axis and having a first and second inlet for receiving a sample and a sheath gas, respectively, and an outlet for directing the sample and sheath gas into the plasma region;
an optical collimation system capturing light from the plasma region during introduction of the sample; and
a sample jet tube holder providing a spring-biased clamp with an operator accessible outside of the housing to move in a first direction separating portions of the spring-biased clamp to receive or remove the sample jet tube and in the second direction allowing the spring-biased clamp to close the portions about the sample jet tube and align the sample jet tube with the axis.

23. The apparatus of claim 22 wherein the sample jet tube includes a radially extending boss interfering with the sample jet tube holder to control an amount of insertion of the sample jet tube in the sample jet tube holder along the axis.

24. The apparatus of claim 22 wherein the sample jet tube holder provides a central bore at an interface of the portions substantially equal to an outer cylindrical periphery of the sample jet tube to seal against the sample jet tube in a closed state.

25. The apparatus of claim 22 wherein the sample jet tube holder is a polymer material.

26. The apparatus of claim 22 wherein the sample jet tube is a high-temperature glass material.

27. The apparatus of claim 22 wherein the sample jet tube holder forms part of a housing wall of a housing portion enclosing a portion of the sample jet tube during operation of the plasma generator.
